(19) United States
(12) Patent Application Publication
(10) Pub. No.: US 2024/0165586 A1
(43) Pub. Date: May 23, 2024

(54) MICROPLASTIC RECOVERY MATERIAL AND MICROPLASTIC RECOVERY DEVICE INCLUDING THE SAME

(71) Applicant: KOREA INSTITUTE OF SCIENCE AND TECHNOLOGY, Seoul (KR)

(72) Inventors: Seong Jin KIM, Seoul (KR); Myoung-Woon MOON, Seoul (KR); Min Seong KANG, Seoul (KR); Seohyun CHO, Seoul (KR); Geunhyeok CHOI, Seoul (KR); Youngjin LEE, Seoul (KR); YOUNG A LEE, Seoul (KR); CHAN YOUNG OH, Seoul (KR)

(21) Appl. No.: 18/458,009

(22) Filed: Aug. 29, 2023

(30) Foreign Application Priority Data
Nov. 18, 2022 (KR) 10-2022-0155570
Apr. 11, 2023 (KR) 10-2023-0047775

(51) Int. Cl. B01J 20/28; B01D 15/02; B01J 20/24; B01J 20/26; C02F 1/28

(52) U.S. Cl. CPC B01J 20/28092; B01D 15/02; B01J 20/24; B01J 20/261; B01J 20/28023; B01J 20/28085; C02F 1/285; C02F 2103/007

(57) ABSTRACT

Provided is a microplastic recovery material according to an embodiment of the inventive concept including a porous structure including a first hierarchical pocket provided in an outer surface thereof, and a nano-protrusion provided on the outer surface. The first hierarchical pocket includes a first pocket and a second pocket that are connected to each other. The first pocket has a diameter of about 1 mm to about 5 mm. The second pocket has a diameter of about 1 μm to about 100 μm.

### CROSS-REFERENCE TO RELATED APPLICATIONS

This U.S. non-provisional patent application claims priority under 35 U.S.C. § 119 of Korean Patent Application Nos. 10-2022-0155570, filed on Nov. 18, 2022, and 10-2023-0047775, filed on Apr. 11, 2023, the entire contents of which are hereby incorporated by reference.

### BACKGROUND

The present disclosure herein relates to a microplastic recovery material and a microplastic recovery device including the same.

Microplastic pollution is a global environmental issue found in oceans and rivers around the world. Microplastics generally refer to small plastic particles having a size that is measured as less than about 5 mm. The microplastics are generated by various causes such as degradation of large plastic articles, industrial process, and microbeads used in personal cleansing agents. These small particles float on the surface of the ocean and are often consumed by marine organisms (fish, shellfish, seaweed, and the like). As the marine organisms eat the microplastics, biological/physical damage to the marine organisms may occur. Harmful chemicals may accumulate in the marine organisms to finally affect human health through the food chain. In order to resolve the environmental issues caused by the microplastic pollution, research on a ban on microbeads in cosmetic products, waste management improvement, promotion of use of biodegradable materials, and the like are carried out.

### SUMMARY

The present disclosure provides a structure of a microplastic recovery material, which is excellent in function of recovering microplastics having different sizes at a time, and a structure of a microplastic recovery device including the microplastic recovery material.

An embodiment of the inventive concept provides a microplastic recovery material including a porous structure including a first hierarchical pocket provided in an outer surface of the porous structure, and a nano-protrusion provided on the outer surface. The first hierarchical pocket may include a first pocket and a second pocket that are connected to each other. The first pocket may have a diameter of about 1 mm to about 5 mm, and the second pocket may have a diameter of about 1 μm to about 100 μm.

In an embodiment, the porous structure may include a polymer fiber.

In an embodiment, the porous structure may include cellulose or poly(vinyl alcohol).

In an embodiment, each of the first pocket and the second pocket may have a shape of an unevenness groove having a semi-spherical shape.

In an embodiment, the first pocket may be connected to the second pocket in a one-to-many manner.

In an embodiment, the nano-protrusion may have a shape of a nano-fiber, a nano-pillar, or a combination thereof.

In an embodiment, the surface of the porous structure may have hydrophilicity.

In an embodiment, the first pocket may have a depth of about 1 mm to about 5 mm, and the second pocket may have a depth of about 1 μm to about 100 μm.

In an embodiment, the porous structure may further include a second hierarchical pocket disposed therein, and the second hierarchical pocket may include a hole and a third pocket connected to the hole.

In an embodiment, the hole may have a diameter of about 1 mm to about 5 mm, and the third pocket may have a diameter of about 1 μm to about 100 μm.

In an embodiment of the inventive concept, a microplastic recovery device may include a rotary shaft, and a microplastic recovery material coupled to the rotary shaft. The microplastic recovery material may include a plurality of first hierarchical pockets disposed in an outer circumferential surface thereof, a plurality of second hierarchical pockets provided therein, and nano-protrusions provided on a surface thereof. Each of the first hierarchical pockets may include a first pocket and a second pocket, which are connected to each other and have different sizes, and each of the second hierarchical pockets may include a hole and a third pocket, which are connected to each other and have different sizes.

In an embodiment, the first hierarchical pockets and the second hierarchical pockets may be disposed to be spaced apart from each other in a thickness direction of the microplastic recovery material.

In an embodiment, the first pocket may have a diameter of about 1 mm to about 5 mm, and the second pocket may have a diameter of about 1 μm to about 100 μm.

In an embodiment, the microplastic recovery material may include cellulose or poly(vinyl alcohol).

### BRIEF DESCRIPTION OF THE FIGURES

The accompanying drawings are included to provide a further understanding of the inventive concept, and are incorporated in and constitute a part of this specification. The drawings illustrate embodiments of the inventive concept and, together with the description, serve to explain principles of the inventive concept. In the drawings:

FIG. 1 is a schematic view illustrating a microplastic recovery material according to an embodiment of the inventive concept;

FIG. 2A is an enlarged view of region aa in FIG. 1;

FIG. 2B is an enlarged view of region bb in FIG. 1;

FIG. 3 is a view illustrating a state after a microplastic recovery material is soaked in water;

FIG. 4A is an enlarged view of region cc in FIG. 3;

FIG. 4B is an enlarged view of region dd in FIG. 3;

FIG. 5 is a view illustrating a state in which a microplastic recovery material recovers microplastics;

FIG. 6 is a view illustrating a state in which a microplastic recovery device recovers microplastics;

FIG. 7A is an enlarged view of region ee in FIG. 6; and

FIG. 7B is an enlarged view of region ff in FIG. 6.

### DETAILED DESCRIPTION

Hereinafter, a microplastic recovery material and a microplastic recovery device including the same according to an embodiment of the inventive concept will be described with reference to the accompanying drawings.

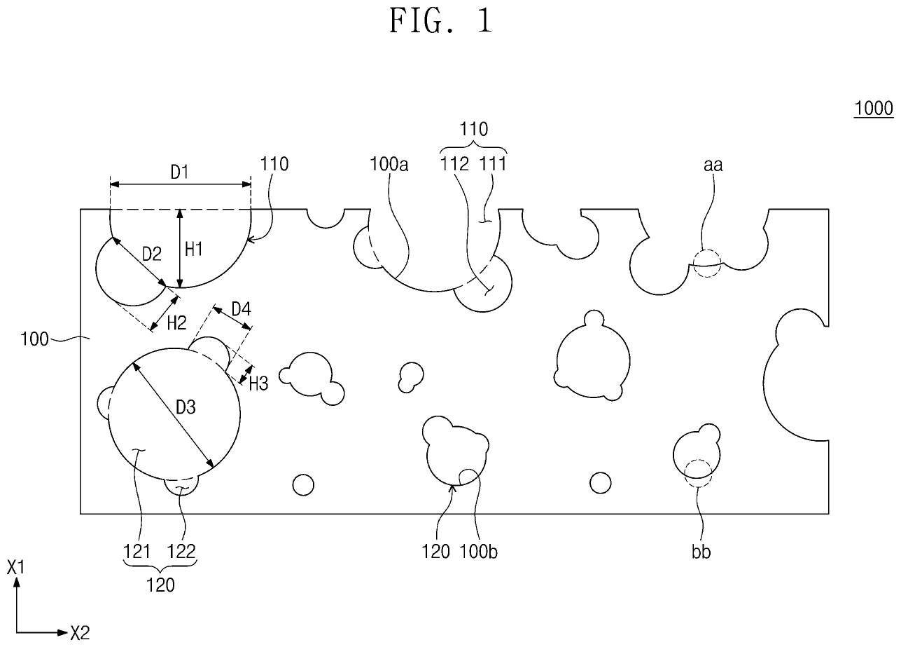

FIG. 1 is a schematic view illustrating a microplastic recovery material according to an embodiment of the inventive concept.

Referring to FIG. 1, a microplastic recovery material 1000 may be provided.

The microplastic recovery material 1000 may include a porous structure 100. The porous structure 100 may include, for example, a polymer fiber. For example, the polymer fiber may include any one of cellulose, rayon, cotton, silk, polystyrene (PS), polyethylene terephthalate (PET), polycarbonate (PC), polypropylene (PP), polylactic acid (PLA), poly(vinylidene fluoride) (PVDF), polytetrafluoroethylene (PTFE), poly(N-isopropylacrylamide) (PNIPAm), poly(2-hydroxyethyl methacrylate) (PHEMA), polyetherimide (PEI), poly(vinyl alcohol) (PVA), polyethylene (PE), polysilsesquioxane (PSQ), polyurethane (PU), poly(ethylene glycol) (PEG), poly(methyl methacrylate) (PMMA), and polycaprolactone (PCL).

Hereinafter, a thickness direction of the porous structure 100 is defined as a first direction X1 in the present disclosure. A direction perpendicular to the thickness direction of the porous structure 100 is defined as a second direction X2.

The porous structure 100 may include first hierarchical pockets 110. The hierarchical pocket used herein may mean a component in which pockets having different sizes are connected to each other or a hole and a pocket that are different in size are connected to each other. The pocket means a partitioned space or a closed space. The pocket means an unevenness groove having a semi-spherical shape similar to “U” when viewed on a cross-sectional view.

The first hierarchical pockets 110 may be disposed in an outer surface 100a of the porous structure 100. Each of the first hierarchical pockets 110 may include a first pocket 111 and a second pocket 112 that are connected to each other.

The first pocket 111 may have a first diameter D1 and a first depth H1. The first diameter D1 means a width between both edges of a semi-sphere constituting the first pocket 111 in the second direction X2. The first depth H1 means a width from any one of both the edges to the lowest portion of the semi-sphere. The first depth H1 also means a width from any one of both the edges in the first direction X1. Each of the first diameter D1 and the first depth H1 may be about 1 mm to about 5 mm.

The second pocket 112 means a space recessed from the first pocket 111. The second pocket 112 have a second diameter D2 and a second depth H2 that are less than the first diameter D1 and the first depth H1, respectively. Each of the second diameter D2 and the second depth H2 may be about 1 μm to about 100 μm.

The first pocket 111 may be connected to the second pocket 112 in a one-to-one or one-to-many manner.

Second hierarchical pockets 120 may be disposed inside the porous structure 100. The second hierarchical pockets 120 may be disposed to be spaced apart from the first hierarchical pockets 110 in the first direction X1. The porous structure 100 may have an inner surface 100b that defines the second hierarchical pockets 120.

Each of the second hierarchical pockets 120 may include a hole 121 and a third pocket 122 that are connected to each other. The hole 121 may have various shapes such as a circular or polygonal shape, when viewed on a cross-sectional view. The hole 121 may have a third diameter D3, and the third diameter D3 may be about 1 mm to about 5 mm.

The third pocket 122 means a space recessed from the hole 121. The third pocket 122 may have a fourth diameter D4 and a third depth H3. Each of the fourth diameter D4 and the third depth H3 may be about 1 μm to about 100 μm.

The hole 121 may be connected to the third pocket 122 in a one-to-one or one-to-many manner.

According to an embodiment, the third pocket 122 may be omitted, and only the hole 121 may be provided inside the porous structure 100.

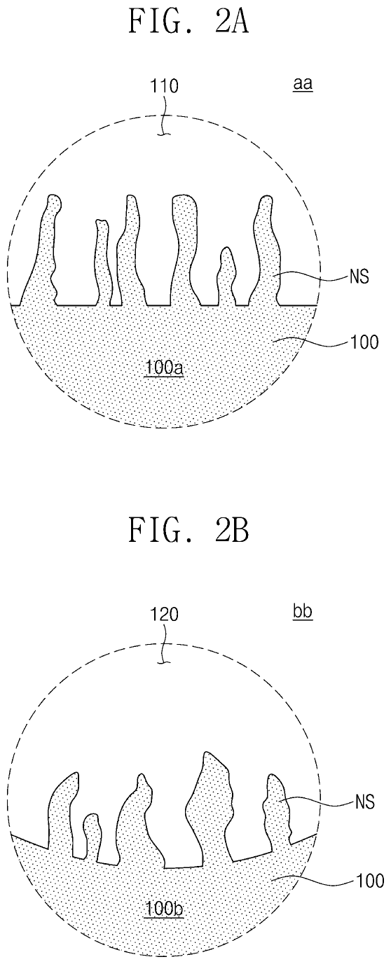

FIG. 2A is an enlarged view of region aa in FIG. 1. FIG. 2B is an enlarged view of region bb in FIG. 1. Referring to FIGS. 1, 2A, and 2B, the porous structure 100 may include nano-protrusions NS that are disposed on each of the outer surface 100a and the inner surface 100b. The nano-protrusions NS may surround each of the first hierarchical pockets 110 and the second hierarchical pockets 120.

Each of the nano-protrusions NS may have a shape protruding from a surface of the porous structure 100. Each of the nano-protrusions NS may have a shape such as a pillar shape or a fiber shape. Each of the nano-protrusions NS may have a shape in which one end is connected to the porous structure 100 and the other end is separated from the porous structure 100. Each of the nano-protrusions NS may have a diameter of about 0.1 nm to about 100 nm, and a length of about 1 nm to about 1,000 nm. Each of the nano-protrusions NS may have a width to height ratio of about 1 to about 50.

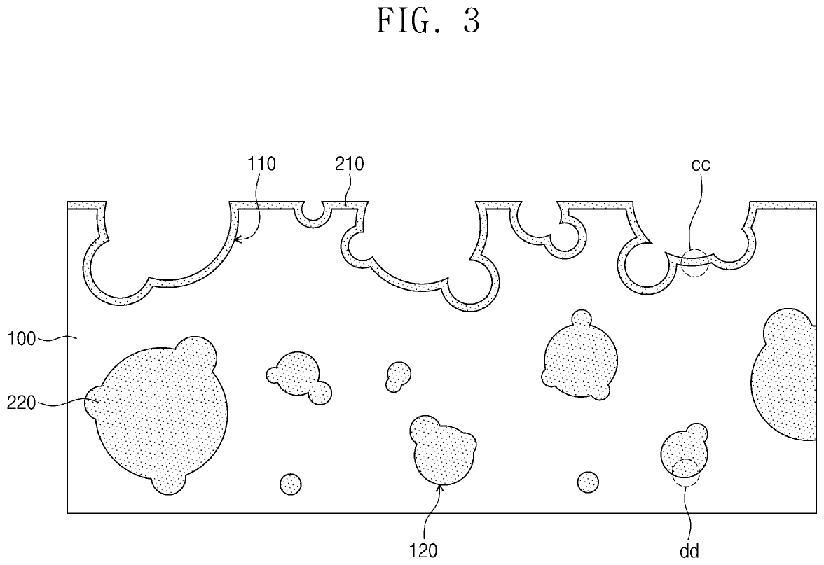

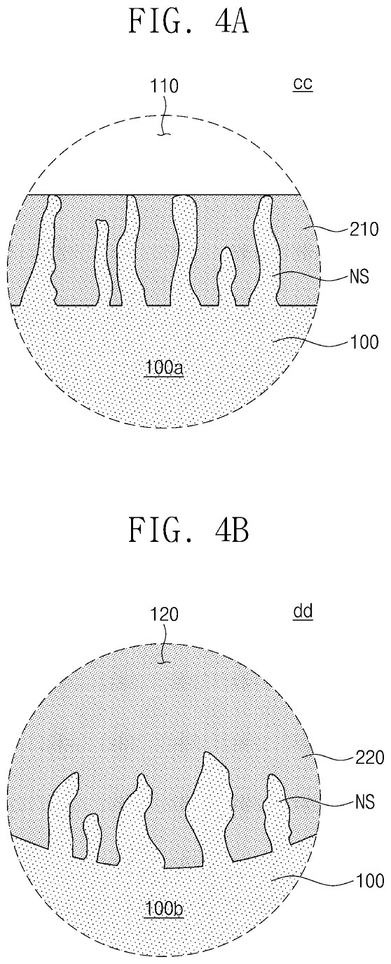

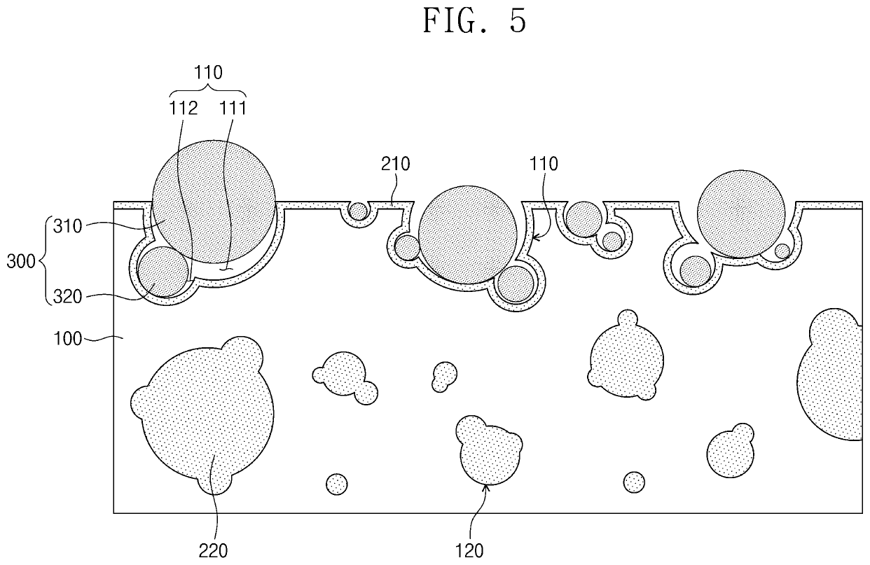

FIG. 3 is a view illustrating a state after a microplastic recovery material according to an embodiment of the inventive concept is soaked in water. FIG. 4A is an enlarged view of region cc in FIG. 3. FIG. 4B is an enlarged view of region dd in FIG. 3.

Referring to FIGS. 3 and 4A, a first water film 210 may remain on an outer surface 100a of a porous structure 100. The first water film 210 may be filled in a portion of a first hierarchical pocket 110. The first water film 210 may be filled between nano-protrusions NS. The first water film 210 may have a linear shape when viewed on a cross-sectional view. The first water film 210 may have a thickness that is similar to a length of each of the nano-protrusions NS.

Referring to FIGS. 3 and 4B, a second water film 220 may remain on an inner surface 100b of the porous structure 100. The second water film 220 may be filled in at least a portion of a second hierarchical pocket 120. The second water film 220 may have a thickness that is greater than the length of each of the nano-protrusions NS. An amount of water included in the second water film 220 may be larger than an amount of water included in the first water film 210.

According to an embodiment of the inventive concept, each of the outer surface 100a and the inner surface 100b of the porous structure 100 may have hydrophilicity. In the present disclosure, having “hydrophilicity” means having a polarity, having a tendency to adsorb water, and having a tendency to congregate in a phase of water, and having an equilibrium contact angle to water of about 20 degrees. The nano-protrusions NS may give the hydrophilicity to each of the outer surface 100a and the inner surface 100b of the porous structure 100 so that the first water film 210 and the second water film 220 remain.

FIG. 5 is a view illustrating a state in which a microplastic recovery material recovers microplastics.

Referring to FIG. 5, microplastics 300 may have various sizes. As one example, the microplastics 300 may include a first microplastic 310 having a size of several millimeters, and a second microplastic 320 having a size of several micrometers.

According to an embodiment of the inventive concept, the first hierarchical pocket 110 of the outer surface 100a may recover both the first microplastic 310 and the second microplastic 320, which are different in size, at the same time or at a time. Specifically, the first microplastic 310 and the second microplastic 320 may move into the first hierarchical pocket 110, the first pocket 111 may selectively recover the first microplastic 310, and the second pocket 112 may selectively recover the second microplastic 320.

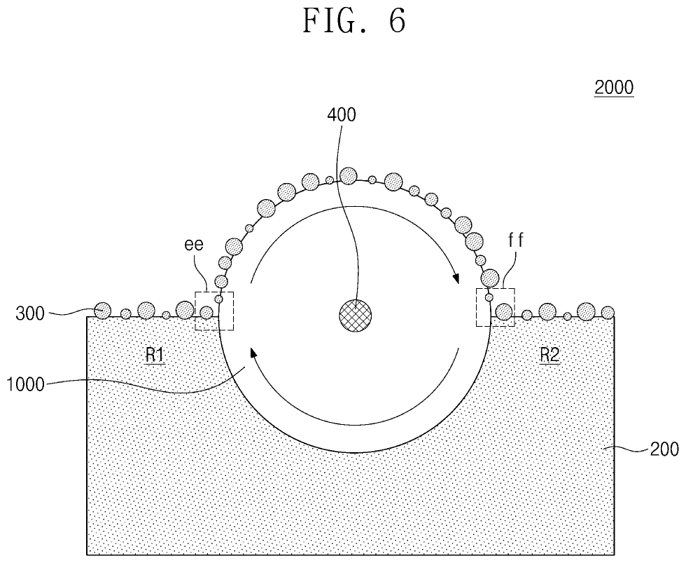

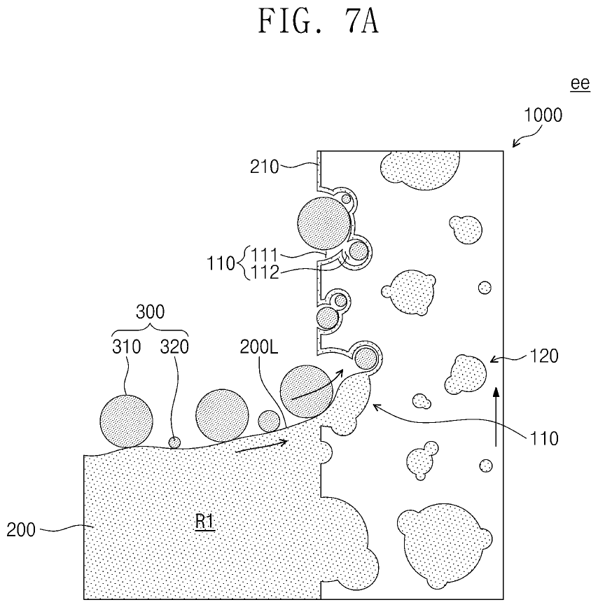

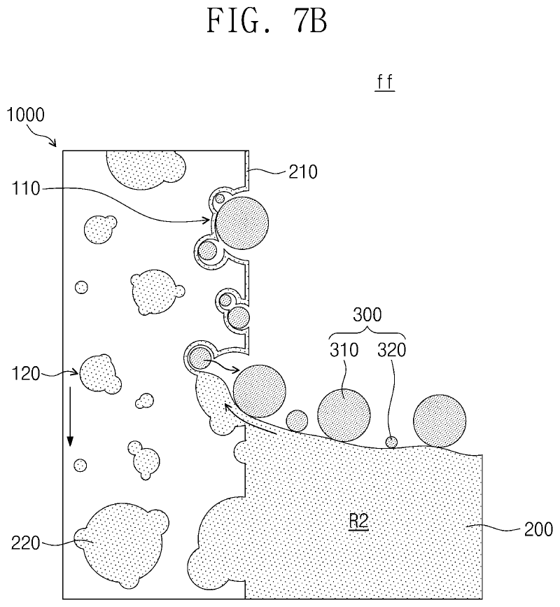

FIG. 6 is a view illustrating a state in which a microplastic recovery device recovers microplastics. FIG. 7A is an enlarged view of region ee in FIG. 6. FIG. 7B is an enlarged view of region ff in FIG. 6.

Referring to FIG. 6, a microplastic recovery device 2000 may include a rotary shaft 400 and a microplastic recovery material 1000 coupled to the rotary shaft 400. As one example, the rotary shaft 400 may rotate in a clockwise direction or in a counterclockwise direction, and the microplastic recovery material 1000 may rotate in the same direction as the rotary shaft 400.

The microplastic recovery material 1000 may rotate in a state in which a portion thereof is soaked in water. The microplastic recovery material 1000 may have a cylindrical shape like, for example, a drum. Here, the microplastic recovery material 1000 may have a radius of several centimeters to several meters. The rotary shaft 400 may be configured to be coupled to a driving means outside the microplastic recovery device 2000 and rotated by power supplied by the driving means. The driving means may be a power system capable of supplying power to the rotary shaft 400, and as one example, the driving means may be an electric motor.

A region facing one side of the microplastic recovery device 2000 may be a microplastic recovery region R1, and a region facing the other side may be a microplastic separation region R2.

As in FIGS. 6 and 7A, in the microplastic recovery region R1, microplastics 300 floating on water 200 may move into a first hierarchical pocket 110 during rotation of the microplastic recovery material 1000. The first hierarchical pocket 110 may be disposed in an outer circumferential surface of the microplastic recovery material 1000.

Specifically, in the microplastic recovery region R1, when the microplastic recovery material 1000 moves out of the water 200, a first water film 210 may be formed on the first hierarchical pocket 110 by nano-protrusions NS. In addition, due to surface hydrophilicity, a concave meniscus may be formed between a water surface 200L and the microplastic recovery material 1000. As a result, due to the Cheerios effect, the microplastics 300 may move onto the microplastic recovery material 1000 and move into the first hierarchical pocket 110. A first microplastic 310 may move into a first pocket 111, and a second microplastics 320 may move into a second pocket 112. According to an embodiment of the inventive concept, as the surface of the microplastic recovery material 1000 has hydrophilicity, the Cheerios effect may be maximized.

The microplastics 300 recovered by the first hierarchical pocket 110 may move from one side to the other side of the microplastic recovery material 1000 according to the rotation of the microplastic recovery material 1000.

As in FIGS. 6 and 7B, in the microplastic separation region R2, the microplastics 300 entering the first hierarchical pocket 110 may move out of the microplastic recovery material 1000 during the rotation of the microplastic recovery material 1000.

According to the rotation of the microplastic recovery material 1000, the water 200 may flow into the first hierarchical pocket 110 due to capillarity when the first hierarchical pocket 110 enters the water 200. As a result, the microplastics 300 entering the first hierarchical pocket 110 may move onto the water 200. According to an embodiment of the inventive concept, as the surface of the microplastic recovery material 1000 has hydrophilicity, capillary suction occurring between the microplastic recovery material 1000 and the water 200 may be maximized. Accordingly, the microplastics 300 may be more easily recovered from the microplastic recovery material 1000.

Moreover, the microplastic recovery material 1000 may include a second hierarchical pocket 120 and nano-protrusions NS therein so that a second water film 220 is formed. As a result, water may be replenished even when a portion of the first water film 210 is damaged by evaporation. Therefore, the outer surface 100a of microplastic recovery material 1000 may be maintained to be in a state of being continuously wet with moisture.

### Method for Manufacturing Microplastic Recovery Material

A porous structure is prepared which includes first pockets, each of which has a surface having a size of about 1 mm to about 5 mm, and holes therein. The porous structure may have a structure of porous foam. The porous structure includes a polymer fiber such as cellulose or poly(vinyl alcohol).

Atmospheric plasma processing is performed on the porous structure without a mask. The atmospheric plasma processing is a process for generating a plasma in atmospheric pressure state (about 760 Torr) not in a vacuum state (generally, about 1 mTorr to about 100 mTorr), and the plasma is known as cold plasma.

The surface of the porous structure, which is exposed to the plasma through the atmospheric plasma processing, is etched to have nano-protrusions having a nanometer scale, and second pockets having a micrometer scale, which are connected to the first pockets, and third pockets having a micrometer scale, which are connected to the holes, are formed. Simultaneously, nano-protrusions having a nanometer scale are formed on each of an outer surface and an inner surface of the porous structure.

An evacuated chamber or ion beam may be used instead of the atmospheric plasma processing.

The microplastic recovery material and the microplastic recovery device including the same according to an embodiment of the inventive concept may recover the microplastics having various sizes by using one recovery material and one recovery device. Furthermore, the microplastic recovery material and the microplastic recovery device including the same according to an embodiment of the inventive concept may be used to recover suspended solids such as green algae.

A microplastic recovery material and a microplastic recovery device including the same according to an embodiment of the inventive concept may include a porous structure including a hierarchical pocket in a surface thereof. The microplastic recovery material may include nano-protrusions on the surface thereof, and the nano-protrusions give surface hydrophilicity to the microplastic recovery material. In the microplastic recovery material, a water film filled in a portion of an inner space of the hierarchical pocket may be formed on the microplastic recovery material during recovering of microplastics on water. The microplastics may move into the microplastic recovery material together.

Although the embodiments of the present invention have been described with reference to the accompanying drawings, it is understood that the present invention should not be limited to these embodiments but various changes and modifications can be made by one ordinary skilled in the art within the spirit and scope of the present invention as hereinafter claimed. Therefore, it should be understood that the embodiments described above are intended to be illustrative and not for purposes of limitation in all aspects.

What is claimed is:

1. A microplastic recovery material comprising:
a porous structure comprising a first hierarchical pocket provided in an outer surface of the porous structure, and a nano-protrusion provided on the outer surface,
wherein the first hierarchical pocket comprises a first pocket and a second pocket that are connected to each other,
wherein the first pocket has a diameter of about 1 mm to about 5 mm, and the second pocket has a diameter of about 1 μm to about 100 μm.

2. The microplastic recovery material of claim 1, wherein the porous structure comprises a polymer fiber.

3. The microplastic recovery material of claim 2, wherein the porous structure comprises cellulose or poly(vinyl alcohol).

4. The microplastic recovery material of claim 1, wherein each of the first pocket and the second pocket has a shape of an unevenness groove having a semi-spherical shape.

5. The microplastic recovery material of claim 1, wherein the first pocket is connected to the second pocket in a one-to-many manner.

6. The microplastic recovery material of claim 1, wherein the nano-protrusion has a shape of a nano-fiber, a nano-pillar, or a combination thereof.

7. The microplastic recovery material of claim 1, wherein the surface of the porous structure has hydrophilicity.

8. The microplastic recovery material of claim 1, wherein the first pocket has a depth of about 1 mm to about 5 mm, and the second pocket has a depth of about 1 μm to about 100 μm.

9. The microplastic recovery material of claim 1, wherein the porous structure further comprises a second hierarchical pocket disposed therein,
wherein the second hierarchical pocket comprises a hole and a third pocket connected to the hole.

10. The microplastic recovery material of claim 9, wherein the hole has a diameter of about 1 mm to about 5 mm, and the third pocket has a diameter of about 1 μm to about 100 μm.

11. A microplastic recovery device comprising:
a rotary shaft; and
a microplastic recovery material coupled to the rotary shaft,
wherein the microplastic recovery material comprises:
a plurality of first hierarchical pockets disposed in an outer circumferential surface thereof;
a plurality of second hierarchical pockets provided therein; and
nano-protrusions provided on a surface thereof,
wherein each of the first hierarchical pockets comprises a first pocket and a second pocket, which are connected to each other and have different sizes, and
each of the second hierarchical pockets comprises a hole and a third pocket, which are connected to each other and have different sizes.

12. The microplastic recovery device of claim 11, wherein the first hierarchical pockets and the second hierarchical pockets are disposed to be spaced apart from each other in a thickness direction of the microplastic recovery material.

13. The microplastic recovery device of claim 11, wherein the first pocket has a diameter of about 1 mm to about 5 mm, and the second pocket has a diameter of about 1 μm to about 100 μm.

14. The microplastic recovery device of claim 11, wherein the microplastic recovery material comprises cellulose or poly(vinyl alcohol).
